(19) United States
(12) Patent Application Publication
(10) Pub. No.: US 2025/0365137 A1
(43) Pub. Date: Nov. 27, 2025

(54) CRYPTOGRAPHIC SECURITY BETWEEN CONTAINERS AND AUTHENTICATED NON-VOLATILE MEMORY

(71) Applicant: Micron Technology, Inc., Boise, ID (US)

(72) Inventors: Paul Lambert, Mountain View, CA (US); Olivier Duval, Hudson, NH (US); Lance W. Dover, Fair Oaks, CA (US)

(73) Assignee: Micron Technology, Inc., Boise, ID (US)

(21) Appl. No.: 19/202,584

(22) Filed: May 8, 2025

Related U.S. Application Data
(60) Provisional application No. 63/651,549, filed on May 24, 2024.

(51) Int. Cl. H04L 9/08; G06F 21/57

(52) U.S. Cl. CPC H04L 9/0825; G06F 21/575; H04L 9/0861

(57) ABSTRACT

An exemplary system includes a computing device configured to host a hypervisor. The hypervisor is configured to create a first container configured to host a first application and is allocated a first location of the plurality of locations of the memory and a second container configured to host a second application and is allocated a second location of the plurality of locations of the memory. During boot of the first container, the first container is configured to generate a cryptographic key that is based on a measurement or characteristic of process code of the first container, a configuration parameter of the first container, or any combination thereof. During boot of the second container, the second container is configured to generate a cryptographic key that is based on a measurement or characteristic of process code of the second container, a configuration parameter of the second container, or any combination thereof.

### CROSS-REFERENCE TO RELATED APPLICATIONS

This application claims the filing benefit of U.S. Provisional Application No. 63/651,549, filed May 24, 2024. This application is incorporated by reference herein in its entirety and for all purposes.

### BACKGROUND OF THE INVENTION

Processes in secure enclaves (e.g., hypervisors) or container software architectures may be with strong separation of access and management of non-volatile memory. Typically, various authentication methodologies may include generation of a public/private key pair to facilitate secure message transmissions. These public/private key pairs in a virtualized environment are typically handled by the hypervisor. However, management by the hypervisor may increase complexity of the hypervisor (and may require more frequent updates) based on differing rules for generating the public/private key pairs for each secure process/container/application.

### BRIEF DESCRIPTION OF THE DRAWINGS

FIG. 1 is a block diagram of a computing system, in accordance with embodiments described herein.

FIG. 2 is a block diagram of a computing system, in accordance with embodiments described herein.

FIG. 3 is a block diagram of a memory system, in accordance with embodiments described herein.

FIG. 4 is a flowchart of a method to establish secure communication sessions with a memory, in accordance with embodiments described herein.

### DETAILED DESCRIPTION

Certain details are set forth below to provide a sufficient understanding of embodiments of the present disclosure. However, it will be clear to one skilled in the art that embodiments of the present disclosure may be practiced without these particular details. Moreover, the particular embodiments of the present disclosure described herein are provided by way of example and should not be used to limit the scope of the disclosure to these particular embodiments. In other instances, well-known circuits, control signals, timing protocols, and software operations have not been shown in detail in order to avoid unnecessarily obscuring the disclosure.

This disclosure describes examples of a virtualized computing architecture where authentication using one or more cryptographic keys within memory may be implemented to establish cryptographic secure sessions to processes/containers/applications by the generation of secure process unique secret keys. The keys may be generated based on one or more measurements or characteristics of the process code, configuration parameters, or any combination thereof to generate unique and repeatable secret keys that are not observable outside the process/container/application. In some embodiments of the disclosure, public key authentication within memory may be implemented to establish cryptographic secure sessions to processes/containers/applications by the generation of secure process unique secret keys. The established secure sessions may be used to share other secrets (e.g., asymmetric or symmetric) that are used to authenticate the process/container/application to the non-volatile memory's controller. By allowing the authentication to take place between the process/container/application and the memory directly, security may be improved overuse of the hypervisor as a centralized trusted entity (as compared with a distributed trusted entity with each process/container/application independently managing their own authentication. In addition, moving authentication outside of the hypervisor may result in the hypervisor being less complex and less prone to updating to accommodate different authentication rules.

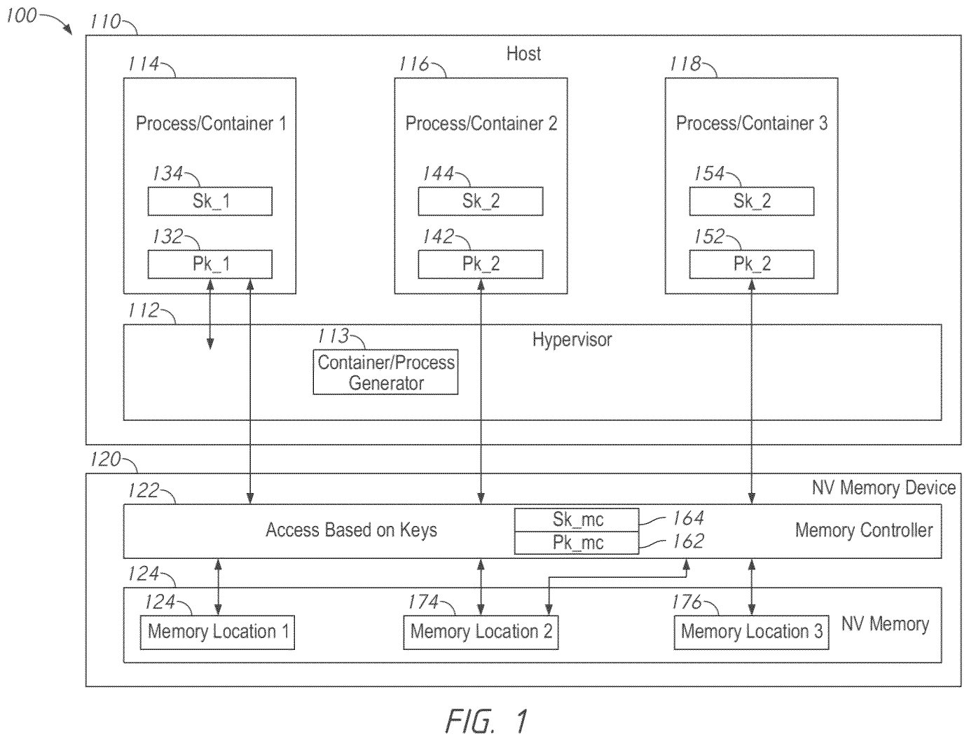

FIG. 1 is a block diagram of a computing system 100, in accordance with embodiments described herein. The computing system 100 generally includes a computing device 110 and a non-volatile memory device 120 configured to store data for the computing device 110. The computing device 110 may be coupled to the non-volatile memory device 120 via an interface capable of routing data transmissions between the computing device 110 and the non-volatile memory device 120.

The computing device 110 may include, for example, a server computer, a laptop computer, a desktop computer, a tablet computer, a smart phone, or any other type of computing device. The computing device 110 may further include one or more physical computing components, such as one or more processor units that are configured to execute instructions to perform operations of the hypervisor 112, the container 114, the container 116, and the container 118.

The computing device 110 may be configured to facilitate a virtualized computing environment. For example, the computing device 110 may host a hypervisor 112. The hypervisor 112 may be any type of hypervisor. The hypervisor 112 may facilitate access to memory 120 for containers, applications, or other processes executing on the hypervisor 112. For example, requests from containers 114, 116, and/or 118 to access memory 120 may be routed through the hypervisor 112. The hypervisor 112 may generally separately manage authentication for processors/containers/applications running on the hypervisor 112. For example, the hypervisor 112 may generate authentication information for processes/containers/applications when such processes/containers/applications are generated by the hypervisor 112. In some examples, a container/process generator 113 of the hypervisor 112 may be configured to manage creation of processes/containers/applications (e.g., a container 114, a container 116, or a container 118), as well as the allocation of physical resources, such as memory of the computing device 110 for storage of data, to the processes/containers/applications.

Generally, a container may refer to a standalone/self-contained executable package of software that includes an entire runtime environment, including an application and dependencies, libraries, binaries, configurations files, etc. to run the application. Containers are tools that may allow many different applications to coexist on the computing device 110 without interfering or interacting with each other. The container acts as a boundary within the computing device 110 that can control which computing resources, interfaces, other applications, etc., that are available and visible to the application. From the perspective of the application, the container may look like it is providing access to the entire computing device 110 and the non-volatile memory device 120, even though it only actually aware of a portion of the computing device 110 and the non-volatile memory device 120 permitted to be visible and accessible by from the container.

The container 114, the container 116, and the container 118 may each have their own operating system and/or application. The container 114, the container 116, and the container 118 may be customized upon instantiation by loading certain software, drivers, network permissions, etc. onto the container 114, the container 116, and the container 118 when they are launched. In some examples, each of the container 114, the container 116, and the container 118 may be configured with unique cryptographic keys. For example, in some embodiments, each of the container 114, the container 116, and the container 118 may be configured with unique public/secret keys pairs (e.g., the public key 132/secret key 134 pair for the container 114, the public key 142/secret key 144 pair for the container 116, and the public key 152/secret key 154 pair for the container 118). In some examples, the public key/secret key pairs for each of the container 114, the container 116, and the container 118 may be generated at instantiation (e.g., using bootstrap code) based on one or more measurements or characteristics of the process code, configuration parameters, or any combination thereof of the respective container 114, the respective container 116, or the respective container 118 (and/or the hypervisor 112) that are not observable outside the container 114, the container 116, or the container 118.

The non-volatile memory device 120 may include a memory controller 122 and non-volatile memory 124. The memory controller 122 may interface between the computing device 110 and the non-volatile memory 124. The non-volatile memory 124 may be configured to store data at various memory locations (e.g., 172, 174, 176, and many other memory locations). In some examples, one or more memory locations 172, 174, and 176 may be allocated to the container 114, the container 116, and the container 118 based on authentication criteria. The memory controller 122 may include a public key 162/secret key 164 pair to be used for secure communication with the container 114, the container 116, and the container 118. The public key 162/secret key 164 pair for the memory controller 122 may be generated by a third party server (not shown) in some examples. The combination of the public key/secret key pairs for each of the container 114, the container 116, and the container 118 and the public key 162/secret key 164 of the memory controller 122 may be used to establish secure sessions between each individual one of the container 114, the container 116, and the container 118 and the memory controller 122. That is, a first component may send a message encrypted with the public key to a second component (e.g., the memory controller 122 may send a message to the container 114 encrypted using the public key 132), and the second component may use its secret key to decrypt the message (e.g., the secret key 134). The established secure sessions may be used to share other secrets (e.g., asymmetric or symmetric) that are used to authenticate the container 114, the container 116, and the container 118 to the memory controller 122. In some embodiments of the disclosure, a secret key may be used with symmetric cryptography such that something may be encrypted and decrypted with the same secret key, and a private key may be associated with asymmetric cryptography such that something is encrypted with a public key and decrypted with a private key. With asymmetric cryptography, the asymmetrical key pair may be a public and private pair of keys that are mathematically related to each other. One or both keys of the asymmetrical key pair may be generated using algorithms, for example, an RSA algorithm or Elliptic Curve Cryptography (ECC) algorithm. In some examples, because the memory controller 122 uses the public keys for each of the container 114, the container 116, and the container 118 for secure communications, the memory controller 122 may include a device access list (not shown) that stores relevant information for each of the container 114, the container 116, and the container 118.

In a virtualized computing environment, applications of varying security levels may be hosted in parallel with one another, and may use shared resources. For example, the container 114, the container 116, and the container 118 may have two or more different security levels between them. To accommodate this type of architecture, secure enclaves with strong separation of access and management of the non-volatile memory 124 may be set up through each of the individual ones of the container 114, the container 116, and the container 118 to prevent one application from accessing shared resources (e.g., the non-volatile memory 124) allocated to another application. For example, the memory location 172 may be allocated to the container 114, the memory location 174 may be allocated to both the container 116 and the container 118, and the memory location 176 may be allocated to the container 118. In this example, the container 116 and the container 118 may be prevented from accessing the memory location 172. The container 114 may be prevented from accessing the memory location 174 and the 176, and the container 114 and the container 116 may be prevented from accessing the memory location 176.

Public key authentication within the non-volatile memory device 120 may be used to establish cryptographic secure sessions with the container 114, the container 116, and the container 118 in order to allocate the memory. In some examples, the public key/secret key pairs for each of the container 114, the container 116, and the container 118 may be generated at instantiation (e.g., using bootstrap code) based on one or more measurements or characteristics of the process code, configuration parameters, or any combination thereof of the respective container 114, the respective container 116, or the respective container 118 (and/or the hypervisor 112) that are not observable outside the container 114, the container 116, or the container 118, while the public key 162/secret key 164 pair for the memory controller 122 may be generated by a third party server (not shown) in some examples. In operation, a first component (e.g., one of the container 114, the container 116, or the container 118 or the memory controller 122) may send a message encrypted with the respective public key to a second component (e.g., the memory controller 122 or one of the container 114, the container 116, or the container 118), and the second component may use its secret key to decrypt the message (e.g., the secret key 134). The second component may be configured to respond with a message encrypted using the public key of the first component, and the first component may decrypt the message using its own secret key. For example, for encrypted communication between the container 114 and the memory controller 122, the container 114 sends a message to the memory controller 122 that is encrypted with the public key 162. The encrypted message from the container 114 is received by the memory controller 122 and decrypted using secret key 164. The memory controller 122 sends a message to the container 114 that is encrypted with the public key 132, and the encrypted message is received by the container 114 and decrypted using secret key 134. Encrypted communications between the other containers 116 and 118, and/or the memory controller 122 is conducted in a similar manner.

This back and forth may be used to establish a secure session between the two components. The established secure session may then be used to share other secrets (e.g., asymmetric or symmetric) that are used to authenticate the container 114, the container 116, and the container 118 to the memory controller 122, and vice versa. That is, the container keys (e.g., the public key 132/secret key 134 pair for the container 114, the public key 142/secret key 144 pair for the container 116, and the public key 152/secret key 154 pair for the container 118) are used to authenticate requests to memory controller and support access decisions. The public keys 132/142/152 of the container 114, the container 116 and the container 118, respectively, may be shared externally to support encryption of information solely to the respective container 114, container 116, or container 118 or encryption of software/data from the non-volatile memory device 120.

This architecture where the containers each have their own keys and manage secure communications directly may provide strong separation of the non-volatile memory 124 usage between the container 114, the container 116, and the container 118 in a hypervisor environment and enables more secure usage of container/application deployments and high security multiple process applications as compared with architectures where the hypervisor 112 manages all authentication centrally.

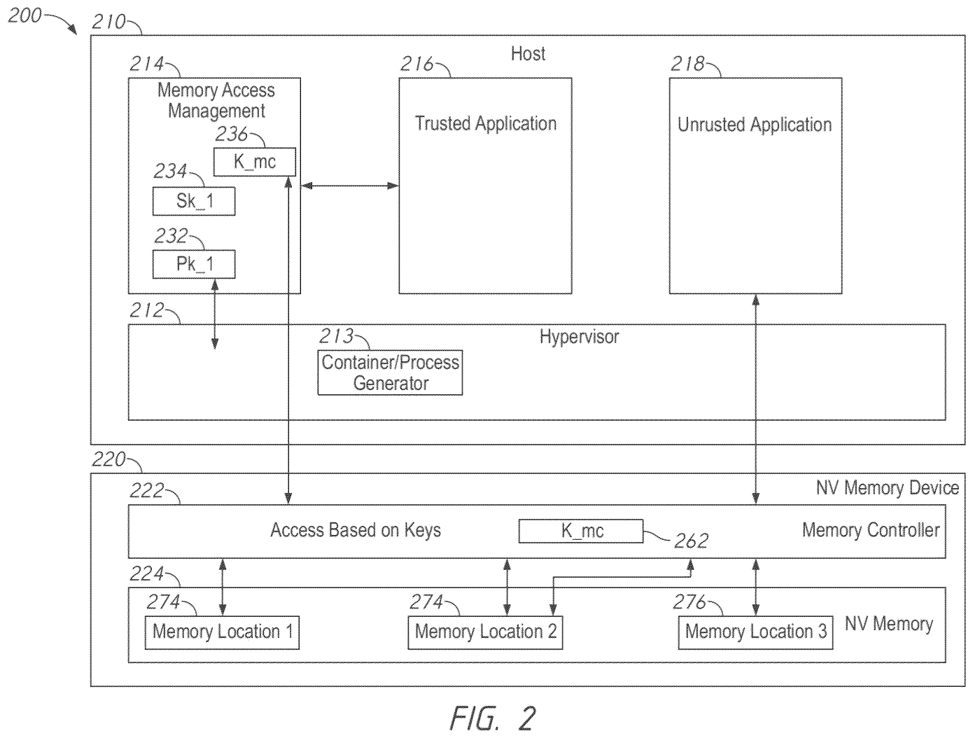

FIG. 2 is a block diagram of a computing system 200, in accordance with embodiments described herein. The computing system 200 generally includes a computing device 210 and a non-volatile memory device 220 configured to store data for the computing device 210. The computing device 210 may be coupled to the non-volatile memory device 220 via an interface capable of routing data transmissions between the computing device 210 and the non-volatile memory device 220.

The computing device 210 may include, for example, a server computer, a laptop computer, a desktop computer, a tablet computer, a smart phone, or any other type of computing device. The computing device 210 may further include one or more physical computing components, such as one or more processor units that are configured to execute instructions to perform operations of the hypervisor 212, the memory management access application container 214, the trusted application container 216, and the untrusted application container 218. The computing device 210 may be configured to facilitate a virtualized computing environment. For example, the computing device 210 may host a hypervisor 212. The hypervisor 212 may be any type of hypervisor. A container/process generator 213 of the hypervisor 212 may be configured to manage creation of processes/containers/applications, such as a memory management access application container 214, a trusted application container 216, and a untrusted application container 218, as well as the allocation of physical resources, such as memory of the computing device 210 for storage of data, to the processes/containers/applications.

Generally, a container may refer to a standalone/self-contained executable package of software that includes an entire runtime environment, including an application and dependencies, libraries, binaries, configurations files, etc. to run the application. Containers are tools that may allow many different applications to coexist on the computing device 210 without interfering or interacting with each other. The container acts as a boundary within the computing device 210 that can control which computing resources, interfaces, other applications, etc., that are available and visible to the application. From the perspective of the application, the container may look like it is providing access to the entire computing device 210 and the non-volatile memory device 220, even though it only actually aware of a portion of the computing device 210 and the non-volatile memory device 220 permitted to be visible and accessible by from the container.

The memory management access application container 214, the trusted application container 216, and the untrusted application container 218 may each have their own operating system and/or application. The memory management access application container 214, the trusted application container 216, and the untrusted application container 218 may be customized upon instantiation by loading certain software, drivers, network permissions, etc. onto the memory management access application container 214, the trusted application container 216, and the untrusted application container 218 when they are launched. In some examples, the memory management access application container 214 may be configured to manage secure memory accesses to the non-volatile memory device 220 based on a symmetrical key 262 of the memory controller 222. To establish a secure communication session with the memory controller 222 to receive the symmetrical key 262 from the memory controller 222, the memory management access application container 214 may be configured with a unique public key 232/secret key 234 pair. In some examples, the public key 232/secret key 234 pair for the memory management access application container 214 may be generated at instantiation (e.g., using bootstrap code) based on one or more measurements or characteristics of the process code, configuration parameters, or any combination thereof, of the memory management access application container 214. The public key 232 may be provided to the memory controller 222, which may then send a message encrypted using the public key 232 to the memory management access application container 214 that includes the symmetrical key 262, and the memory management access application container 214 may store the symmetrical key 262 as the symmetrical key 236. In some examples, the trusted application container 216 may include a trusted application that has been allocated access to secure memory locations of the non-volatile memory 224 (as well as unsecured memory locations), while the untrusted application container 218 is an untrusted application that is restricted from accessing the secured areas, and is only able to store data in unsecured locations. In some examples, the memory controller 222 may have a device access list that is configured to maintain which areas of the non-volatile memory 224 are allocated to each of the trusted application container 216 and the untrusted application container 218.

The non-volatile memory device 220 may include the memory controller 222 and non-volatile memory 224. The memory controller 222 may interface between the computing device 210 and the non-volatile memory 224. The non-volatile memory 224 may be configured to store data at various memory locations (e.g., memory location 272, memory location 274, memory location 276, and many other memory locations). In some examples, one or more memory locations memory location 272, memory location 274, and memory location 276 may be allocated to the memory management access application container 214, the trusted application container 216, and the untrusted application container 218 based on authentication criteria, with one or more of the memory locations memory location 272, memory location 274, and memory location 276 designated as secure memory locations. The memory controller 222 may include the symmetrical key 262 to be used for secure communication with the memory controller 222 for storage of data at the secure memory location(s). The symmetrical key 262 for the memory controller 222 may be generated by a third-party server (not shown) in some examples. The symmetrical key 262 is a secret key that is not known to any component other than the memory management access application container 214 and the memory controller 222, and is used for secure communications in both directions between the memory management access application container 214 and the memory controller 222. That is, the memory management access application container 214 and the memory controller 222 both use the symmetrical key 262 (which is also stored in memory management access application container 214 as symmetrical key 236) to encrypt and decrypt messages sent to one another. The established secure sessions between the memory management access application container 214 and the memory controller 222 may be used to share other secrets (e.g., asymmetric or symmetric) that are used to authenticate one or more trusted applications, such as the memory management access application container 214. Thus, rather than using the public key/private key (asymmetrical) authentication as described for memory accesses as described in FIG. 1, the memory management access application container 214 and the memory controller 222 may use symmetrical key authentication via the symmetrical key 236 and symmetrical key 262.

This architecture where the memory management access application container 214 manages secure communications directly may provide strong separation of the non-volatile memory 224 usage between the memory management access application container 214, the trusted application container 216, and the untrusted application container 218 in a hypervisor environment and enables more secure usage of container/application deployments and high security multiple process applications as compared with architectures where the hypervisor 212 manages all authentication centrally.

The example of FIG. 1 describes secure authentication and communication for memory accesses using public key/private key (asymmetrical) authentication, and the example of FIG. 2 describes secure authentication and communication for memory accesses using symmetrical key authentication (e.g., via the symmetrical key 236 and symmetrical key 262). However, it will be appreciated that other embodiments of the disclosure may use other processes and techniques using additional or alternative cryptographic keys for authentication, encryption, and or communication.

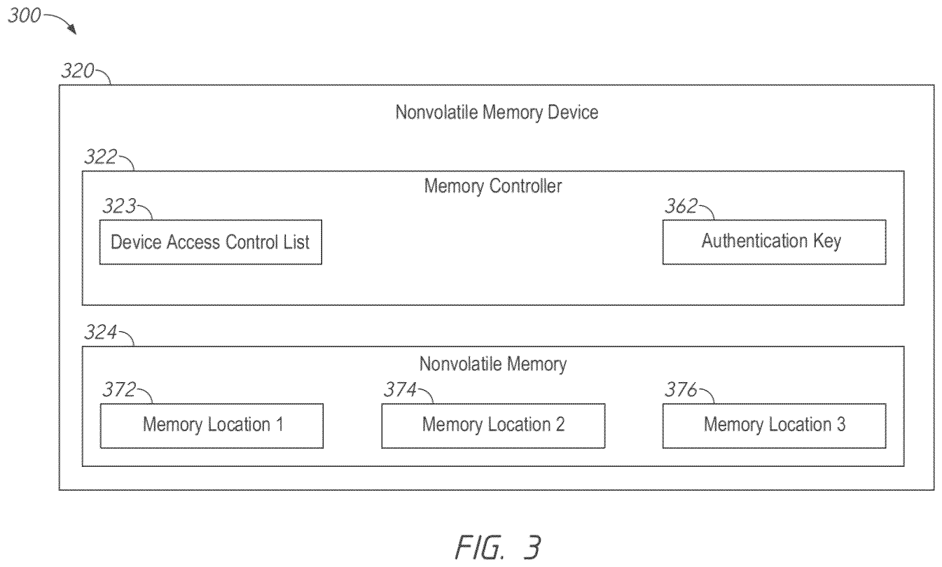

FIG. 3 is a block diagram of a memory system 300, in accordance with embodiments described herein. The memory system 300 generally includes non-volatile memory device 320 configured to store data for one or more host computing devices. The non-volatile memory device 320 may be implemented in any of the non-volatile memory device 120 of FIG. 1 or the non-volatile memory device 220 of FIG. 2.

The non-volatile memory device 320 may include a memory controller 322 and non-volatile memory 324. The memory controller 322 may interface between the host computing devices and the non-volatile memory 324. The non-volatile memory 324 may be configured to store data at various memory locations (e.g., memory location 372, memory location 374, memory location 376, and many other memory locations). In some examples, one or more memory locations memory location 372, memory location 374, memory location 376 may be allocated to respective containers hosted on the host computing devices based on authentication criteria. In some examples, the memory controller 322 may include an access control list 323 that is configured to store or maintain which locations memory location 372, memory location 374, memory location 376 of the non-volatile memory 324 are allocated to which application/process/container in order to prevent unauthorized access to an unallocated location memory location 372, memory location 374, memory location 376 of the non-volatile memory 324. In some examples, the memory controller 322 may have an authentication key 362 used during secure communication sessions with applications/processes/containers. In some examples, authentication key 362 may include a public key/secret key pair (e.g., asymmetrical authentication) to be used to receive secure communication from the applications/processes/containers, and may use respective public/secret key pairs of the applications/processes/containers to send secure messages. In other examples, authentication key 362 may include a symmetrical key for secure communications in both directions.

This architecture where the memory controller 322 communicates directly with the applications/processes/containers via secured communications may provide strong separation of the non-volatile memory 324 usage between the applications/processes/containers in a hypervisor environment and enables more secure usage of container/application deployments and high security multiple process applications as compared with architectures where a hypervisor manages all authentication centrally.

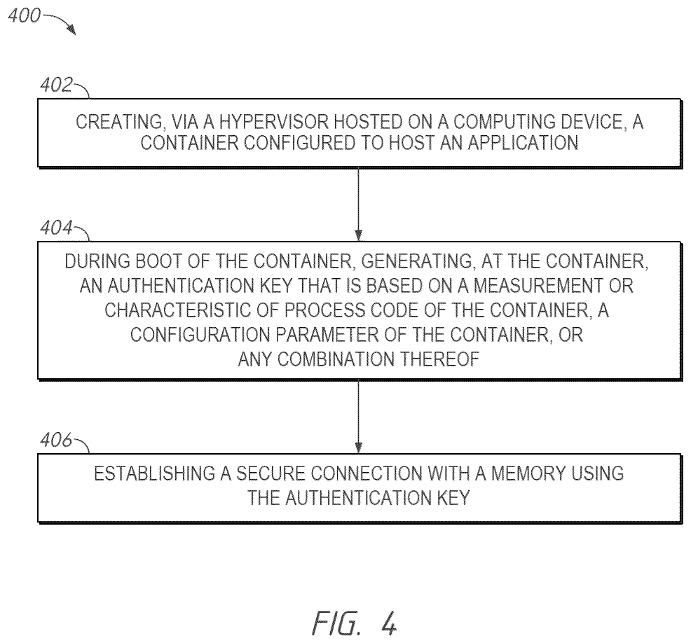

FIG. 4 is a flowchart of a method 400 to establish secure communication sessions with a memory, in accordance with embodiments described herein. The method 400 may be implemented, at least in part, using the computing system 100 of FIG. 1, the computing system 200 of FIG. 2, the memory system 300 of FIG. 3, or any combination thereof.

The method 400 includes creating, for example, via a hypervisor hosted on a computing device, a container configured to host an application, at 402. The hypervisor may include the hypervisor 112 of FIG. 1 or the hypervisor 212 of FIG. 2. The container may include any of the container 114, the container 116, or the container 118 of FIG. 1 and/or the memory management access application container 214, the trusted application container 216, or the untrusted application container 218 of FIG. 2.

The method 400 may further include during boot of the container, generating, at the container, an authentication key that is based on a measurement or characteristic of process code of the container, a configuration parameter of the container, or any combination thereof, at 404. The authentication key may include any of the public key 132/secret key 134 pair, the public key 142/secret key 144 pair, or the public key 152/secret key 154 pair of FIG. 1 and/or the public key 132/secret key 134 pair of FIG. 1. In some examples, the method 400 may include generating an asymmetrical key pair as the authentication key. The asymmetrical key pair may be a public and private pair of keys that are mathematically related to each other. In some examples, the method 400 may further include providing a public key of the asymmetrical key pair to a memory controller of the memory. In some examples, the method 400 may further include decrypting a message received from the memory encrypted using the public key of the asymmetrical key pair encrypted using a secret key of the asymmetrical key pair.

In some examples, the method 400 may include receiving a second authentication key from the memory that is associated with the memory for use in secure communications with the memory. The second authentication key may include the public key 162/secret key 164 of FIG. 1 or the symmetrical key 262 of FIG. 2. In some examples, the method 400 may further include receiving, from the memory, a public key of an asymmetrical key pair as the second authentication key. In some examples, the method 400 may further include encrypting a message to the memory using the public key of the asymmetrical key pair. In some examples, the method 400 may further include receiving, from the memory, a symmetrical key as the second authentication key. In some examples, the method 400 may further include encrypting messages from the container to the memory and decrypting messages from the memory to the container using the symmetrical key.

The method 400 may further include establishing a secure connection with a memory using the authentication key, at 406. The memory may include the non-volatile memory device 120 of FIG. 1, the non-volatile memory device 220 of FIG. 2, and/or the non-volatile memory device 320 of FIG. 3. In some examples, the method 400 may further include hosting a memory access management application at the container to facilitate secure communications between the memory and other applications or containers. The memory access management application may include the memory management access application container 214 of FIG. 2.

In some examples, the method may further include creating, via the hypervisor hosted on the computing device, a second container configured to host a second application, during boot of the second container, generating, via the second container, a second authentication key different than the authentication key that is based on a measurement or characteristic of process code of the second container, a configuration parameter of the second container, or any combination thereof, and establishing a secure connection with a memory using the second authentication key.

Although the detailed description describes certain preferred embodiments and examples, it will be understood by those skilled in the art that the scope of the disclosure extends beyond the specifically disclosed embodiments to other alternative embodiments and/or uses of the embodiments and obvious modifications and equivalents thereof. In addition, other modifications which are within the scope of the disclosure will be readily apparent to those of skill in the art. It is also contemplated that various combinations or sub-combination of the specific features and aspects of the embodiments may be made and still fall within the scope of the disclosure. It should be understood that various features and aspects of the disclosed embodiments can be combined with or substituted for one another in order to form varying mode of the disclosed embodiments. Thus, it is intended that the scope of at least some of the present disclosure should not be limited by the particular disclosed embodiments described above.

What is claimed is:

1. A method comprising:
creating, via a hypervisor hosted on a computing device, a container configured to host an application;
during boot of the container, generating, at the container, a cryptographic key that is based on a measurement or characteristic of process code of the container, a configuration parameter of the container, or any combination thereof;
establishing a secure connection with a memory using the cryptographic key.

2. The method of claim 1, further comprising generating an asymmetrical key pair as the cryptographic key.

3. The method of claim 2, further comprising providing a public key of the asymmetrical key pair to a memory controller of the memory.

4. The method of claim 3, further comprising decrypting a message received from the memory encrypted using the public key of the asymmetrical key pair encrypted using a secret key of the asymmetrical key pair.

5. The method of claim 1, further comprising receiving a second cryptographic key from the memory that is associated with the memory for use in secure communications with the memory.

6. The method of claim 5, further comprising receiving, from the memory, a public key of an asymmetrical key pair as the second cryptographic key.

7. The method of claim 6, further comprising encrypting a message to the memory using the public key of the asymmetrical key pair.

8. The method of claim 5, further comprising receiving, from the memory, a symmetrical key as the second cryptographic key.

9. The computing device of claim 8, further comprising encrypting messages from the container to the memory and decrypting messages from the memory to the container using the symmetrical key.

10. The method of claim 1, further comprising:
creating, via the hypervisor hosted on the computing device, a second container configured to host a second application;
during boot of the second container, generating, via the second container, a second cryptographic key different than the cryptographic key that is based on a measurement or characteristic of process code of the second container, a configuration parameter of the second container, or any combination thereof;
establishing a secure connection with a memory using the second cryptographic key.

11. A computing device comprising:
at least one processor; and
computer readable media encoded with instructions that, when executed by the at least one processor, cause the computing node to:
creating, via a hypervisor, a container configured to host an application;
during boot of the container, generating, at the container, an authentication key that is based on a measurement or characteristic of process code of the container, a configuration parameter of the container, or any combination thereof;
establishing a secure connection with a memory using the authentication key.

12. The computing device of claim 11, wherein the instructions further cause the at least one processor to generate an asymmetrical key pair as the authentication key.

13. The computing device of claim 12, wherein the instructions further cause the at least one processor to provide a public key of the asymmetrical key pair to a memory controller of the memory.

14. The computing device of claim 13, wherein the instructions further cause the at least one processor to decrypt a message received from the memory encrypted using the public key of the asymmetrical key pair encrypted using a secret key of the asymmetrical key pair.

15. The computing device of claim 11, wherein the instructions further cause the at least one processor to receive a second authentication key from the memory that is associated with the memory for use in secure communications with the memory.

16. The computing device of claim 15, wherein the instructions further cause the at least one processor to receive, from the memory, a public key of an asymmetrical key pair as the second authentication key.

17. The computing device of claim 16, wherein the instructions further cause the at least one processor to encrypt a message to the memory using the public key of the asymmetrical key pair.

18. The computing device of claim 15, wherein the instructions further cause the at least one processor to receive, from the memory, a symmetrical key as the second authentication key.

19. The computing device of claim 18, wherein the instructions further cause the at least one processor to encrypt messages from the container to the memory and decrypt messages from the memory to the container using the symmetrical key.

20. The computing device of claim 11, wherein the instructions further cause the at least one processor to host a memory access management application at the container to facilitate secure communications between the memory and other applications or containers.

21. A computing system comprising:
a computing device configured to host a hypervisor; wherein the hypervisor is configured to create a first container configured to host a first application and is allocated a first location of the plurality of locations of the memory and a second container configured to host a second application and is allocated a second location of the plurality of locations of the memory, wherein, during boot of the first container, the first container is configured to generate a first cryptographic key that is based on a measurement or characteristic of process code of the first container, a configuration parameter of the first container, or any combination thereof, wherein, during boot of the second container, the second container is configured to generate a second cryptographic key that is based on a measurement or characteristic of process code of the second container, a configuration parameter of the second container, or any combination thereof, and
a non-volatile memory comprising non-volatile memory having a plurality of storage locations and a memory controller; wherein the memory controller is configured to establish a first secured communication session with the first container based on the first cryptographic key and is configured to allocate a first location of the plurality of locations of the non-volatile memory, wherein the memory controller is configured to establish a second secured communication session with the second container based on the second cryptographic key and is configured to allocate a second location of the plurality of locations of the non-volatile memory.

22. The computing system of claim 21, wherein the first container is configured to provide a public key of the first cryptographic key to the memory controller to establish the first secure communication session.

23. The computing system of claim 22, wherein the memory controller is configured to provide a message that includes a public key of a third cryptographic key associated with the memory controller to the container, wherein the message is encrypted using the public key of the first cryptographic key.

24. The computing system of claim 23, wherein the second container is configured to provide a public key of the second cryptographic key to the memory controller to establish the second secure communication session, and wherein the memory controller is configured to provide a second message that includes the public key of the third cryptographic key associated with the memory controller to the container, wherein the message is encrypted using the public key of the second cryptographic key.

25. The computing system of claim 22, wherein the memory controller is configured to provide a message that includes a symmetrical key of a third cryptographic key associated with the memory controller to the container, wherein the message is encrypted using the public key of the first cryptographic key.

26. The computing system of claim 23, wherein the computing device is configured to host a third container hosting a third application is configured to send a message to the first container indicating that the third container is hosting a trusted application, wherein the message is encrypted using the public key of the first cryptographic key, wherein the first container is configured to communicate with the memory controller using the symmetrical key to establish a third storage location of the plurality of storage locations of the non-volatile memory for allocation to the third container.
